(19) United States
(12) Patent Application Publication
(10) Pub. No.: US 2011/0061493 A1
(43) Pub. Date: Mar. 17, 2011

(54) TRANSMISSION, PARTICULARLY DUAL-CLUTCH TRANSMISSION

(75) Inventors: Tim Bartling, Aachen (DE); Peter Nissen, Aachen (DE); Nadir Zaki, Aachen (DE)

(73) Assignee: GIF Gesellschaft fuer Industrieforschung mbH, Alsdorf (DE)

(21) Appl. No.: 12/736,666

(22) PCT Filed: Apr. 28, 2009
(86) PCT No.: PCT/DE2009/000586

§ 371 Date: Nov. 16, 2010

(30) Foreign Application Priority Data
Apr. 28, 2008 (DE) 10 2008 021 133.8
Sep. 24, 2008 (DE) 10 2008 048 799.6

(51) Int. Cl. F16H 37/08; F16H 37/06

(52) U.S. Cl. 74/665 D

(57) ABSTRACT

The aim of the invention is to be able to make transmissions, in particular dual-clutch transmissions, more stable and compact, especially in respect of a variable moment load. The aim is achieved by a transmission comprising two coaxial transmission input shafts, two countershafts on which gear wheels designed as idlers are rotatably mounted, gear wheels that are arranged in a rotationally fixed and axially successive manner on the two transmission input shafts, are designed as fixed gears, and indirectly or directly mesh with the idlers and thus define different gears, coupling devices which are mounted in a rotationally fixed and axially movable manner on the two countershafts and are to be axially moved by means of adjusting mechanisms in order to connect one respective idler in a rotationally fixed manner to the respective countershaft, and one respective output gear which is mounted on the two countershafts and meshes with teeth of an output member. A reverse gear is defined by an intermediate shaft on which a fixed intermediate shaft gear that immediately meshes with one of the idlers as well as a second fixed intermediate shaft gear that immediately meshes with one of the fixed gears defining the first gear are arranged in a rotationally fixed manner. In the axial sequence of gears, the fixed gear defining the first gear and the reverse gear is arranged on the axially outer side.

The invention relates, on the one hand, to a transmission having two transmission input shafts disposed coaxial to one another, having two countershafts on which gear wheels for the different gears, configured as idler gear wheels, are mounted so as to rotate, having gear wheels for the different gears, configured as fixed gear wheels, disposed on the two transmission input shafts so as to rotate with them and disposed in an axial sequence, which stand in gear engagement with the idler gear wheels, directly or indirectly, and thereby define different gears, having coupling devices that are mounted on the two countershafts so as to rotate with them and in axially movable manner, and can be moved axially by means of setting devices, in order to connect a idler gear wheel, in each instance, with the corresponding countershaft, so as to rotate with it, and having a power take-off gear wheel, attached to the two countershafts, in each instance, which gear wheels stand in gear engagement with a gearing of the power take-off, whereby a reverse gear is defined by an intermediate shaft, on which a first intermediate shaft fixed gear wheel, which directly stands in gear engagement with a idler gear wheel of the idler gear wheels, and a second intermediate shaft fixed gear wheel that directly stands in gear engagement with a fixed gear wheel of the fixed gear wheels that defines first gear G1, are mounted so as to rotate with it. On the other hand, the invention particularly relates to a dual-clutch transmission having two clutches.

Such transmissions, particularly configured as dual-clutch transmissions, having two transmission input shafts disposed coaxial to one another, having two countershafts on which gear wheels for the different gears, configured as idler gear wheels, are mounted so as to rotate, having gear wheels for the different gears, configured as fixed gear wheels, disposed on the two transmission input shafts so as to rotate with them and disposed in an axial sequence, which stand in gear engagement with the idler gear wheels, directly or indirectly, and thereby define different gears, having coupling devices that are mounted on the two countershafts so as to rotate with them and in axially movable manner, and can be moved axially by means of setting devices, in order to connect a idler gear wheel, in each instance, with the corresponding countershaft, so as to rotate with it, and having a power take-off gear wheel, attached to the two countershafts, in each instance, which gear wheels stand in gear engagement with a gearing of the power take-off, are sufficiently known from the state of the art, for example from DE 103 05 241 A1 or from DE 10 2004 032 498 A1. In this connection, DE 10 2004 032 498 A1 particularly discloses a reverse gear that is defined by means of an intermediate shaft on which a first intermediate shaft fixed gear wheel that stands in direct gear engagement with a specific idler gear wheel of the idler gear wheels, and a second intermediate shaft fixed gear wheel that stands in direct gear engagement with a fixed gear wheel of the fixed gear wheels that defines first gear, are disposed so as to rotate with it, in order to make available a particularly compact transmission in this manner.

Proceeding from this, it is the task of the present invention to make available a compact transmission, particularly a compact dual-clutch transmission, which is nevertheless very stable and constant, also with regard to changing moment stress.

As a solution, a transmission of the type stated, having two transmission input shafts disposed coaxial to one another, having two countershafts on which gear wheels for the different gears, configured as idler gear wheels, are mounted so as to rotate, having gear wheels for the different gears, configured as fixed gear wheels, disposed on the two transmission input shafts so as to rotate with them and disposed in an axial sequence, which stand in gear engagement with the idler gear wheels, directly or indirectly, and thereby define different gears, having coupling devices that are mounted on the two countershafts so as to rotate with them and in axially movable manner, and can be moved axially by means of setting devices, in order to connect a idler gear wheel, in each instance, with the corresponding countershaft, so as to rotate with it, and having a power take-off gear wheel, attached to the two countershafts, in each instance, which gear wheels stand in gear engagement with a gearing of the power take-off, whereby a reverse gear is defined by an intermediate shaft, on which a first intermediate shaft fixed gear wheel, which directly stands in gear engagement with an idler gear wheel of the idler gear wheels, and a second intermediate shaft fixed gear wheel that directly stands in gear engagement with a fixed gear wheel of the fixed gear wheels that defines first gear, are mounted so as to rotate with it, is proposed, which is characterized in that the fixed gear wheel that defines first gear and reverse gear is disposed axially on the outside, in the axial sequence. In this manner of construction, this fixed gear wheel can be disposed in the immediate vicinity of a bearing, so that loads that can occur during normal operation or also in the case of moment changes are minimized, and accordingly, the gear engagement forces or vibrations that particularly can occur during a moment change are minimized.

Preferably, the fixed gear wheel that defines the second gear is also disposed axially on the outside, specifically on the side of the axial sequence that faces away from the fixed gear wheel. In this manner of construction, the gear wheels that are subject to the greatest stress due to loads and moment changes, particularly the idler gear wheels, in each instance, with their large radii, are disposed in the vicinity of bearings, so that the torques or forces, in each instance, can be absorbed correspondingly well. Particularly in the case of the lower gears, in other words particularly in the case of first and second gear, the loads that result from the torques of the engine are the greatest, because of the radii of the gear wheels, in each instance, particularly of the idler gear wheels, in each instance, at the same power spectrum of the driving engine, in each instance.

This particularly holds true if the first intermediate shaft fixed gear wheel is disposed at the axial height of the fixed gear wheel that defines second gear, so that here, too, a bearing at the shortest possible distance can be guaranteed.

If the fixed gear wheel that defines first gear and reverse gear is disposed axially on a side that faces away from the clutches, and specifically, the fixed gear wheel that defines second gear is disposed axially on a side facing the clutches, this brings about a relatively great length of the shaft to the start-up gears used frequently and under great loads, namely to first gear and reverse gear, which should actually be avoided, according to the state of the art. On the other hand, in a manner according to the invention, this is specifically minimized, in terms of its harmful effects, by means of the closeness to a bearing, whereby in many connections, start-up in second gear is preferred, and in the case of such an arrangement, this specifically leads to a short path, and thus to relatively low torsions.

In the case of such a configuration, in particular, it can be advantageous if the two transmission input shafts can be coupled with one another, so that both clutches can be used when starting up.

On the other hand, it can be advantageous if the fixed gear wheel that defines first gear and reverse gear is disposed axially on a side that faces the clutches. Supplementally, the fixed gear wheel that defines second gear can be disposed axially on a side that faces away from the clutches. Such a configuration eliminates the disadvantages mentioned above in connection with the alternatively listed embodiment, and particularly supplementally utilizes the advantage of the arrangement according to the invention, that only one of the two clutches, namely the clutch for first gear and reverse gear, is actually used for start-up purposes. This clutch can then be designed to be correspondingly larger or able to withstand more stress.

Particularly in the case of a dual-clutch transmission, the two clutches can be are disposed axially at the same height, preferably with an overlap of more than 50%, and radially on different radii, relative to one another, so that a different design is brought about simply as the result of the different radii.

Thus, it can furthermore be advantageous if the clutch connected with the fixed gear wheel that defines first gear and reverse gear is disposed radially on the outside, so that this clutch, because of its greater radius, also can transfer greater torques. In this connection, it essentially holds true that the moment that can be transferred by way of a clutch is proportional to the clamping force, the friction coefficient in the clutch, the radius, and the number of friction surfaces.

Usually, the two clutches of a dual-clutch transmission have multiple clutch disks, in each instance, which are generally disposed next to one another, per clutch, for example as driving steel disks and power take-off friction disks, or as power take-off steel disks and driving friction disks, and can be pressed onto one another, together, thereby leading to a certain axial expanse, whereby such an axial expanse of the clutches, in each instance, of course must also be present in the case of only two clutch surfaces, in each instance, which are pressed against one another accordingly, since the modules that carry these clutch surfaces have a certain expanse. In this regard, the term of “clutches disposed axially at the same height” does not necessarily mean that the axial expanse of the two clutches is the same and that their center planes, which lie perpendicular to the axis of rotation, must lie within one another. Instead, it is already sufficient if only one module of a clutch, in each instance, lies axially at the same height of another module of the second clutch.

If the two transmission input shafts can be coupled with one another, a power can be transferred to a countershaft of the dual-clutch transmission by the two transmission input shafts, at the same time. This has the advantage that the clutch forces of both clutches can be utilized, so that in start-up situations, in particular, greater torques can be transferred, or the individual-clutches can be treated gently. Clutching of both transmission input shafts, on the other hand, the actual advantages of a dual-clutch transmission are lost, since then, preventative engagement or synchronization of a gear that is not actually in use as yet is not possible. On the other hand, the clutch can generally be released very quickly between the two transmission input shafts, since greater torques generally have to be transferred only for a very short time, so that the advantages of a dual-clutch transmission can immediately be utilized once again.

In particular, when using a motor vehicle, it is advantageous if the power take-off comprises a differential, thereby making it possible to make the dual-clutch transmission in the motor vehicle in particularly compact manner.

Additional advantages, goals, and properties of the present invention will be explained using the drawing appended to the following description, in which transmissions are shown as examples, in which a fixed gear defining a first gear and a reverse gear, in each instance, is disposed axially on the outside, in an axial sequence. Components that agree, at least essentially, in the figures, with regard to their function, can be identified with the same reference numbers, in this connection, whereby these components are not necessarily numbered and explained in all the figures.

In the drawing, the figures show:

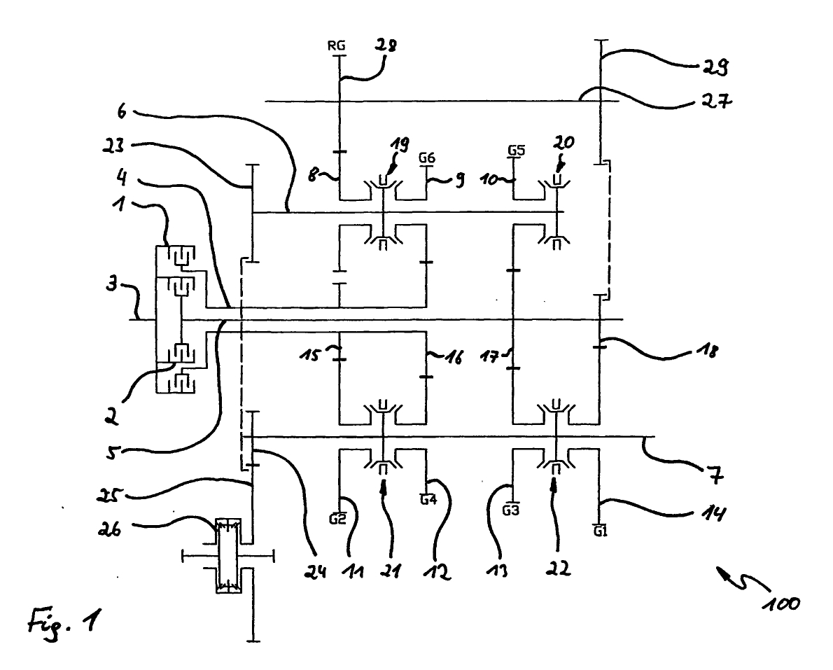

FIG. 1 a schematic line representation of a transmission according to the invention, with transmission input shafts and countershafts;

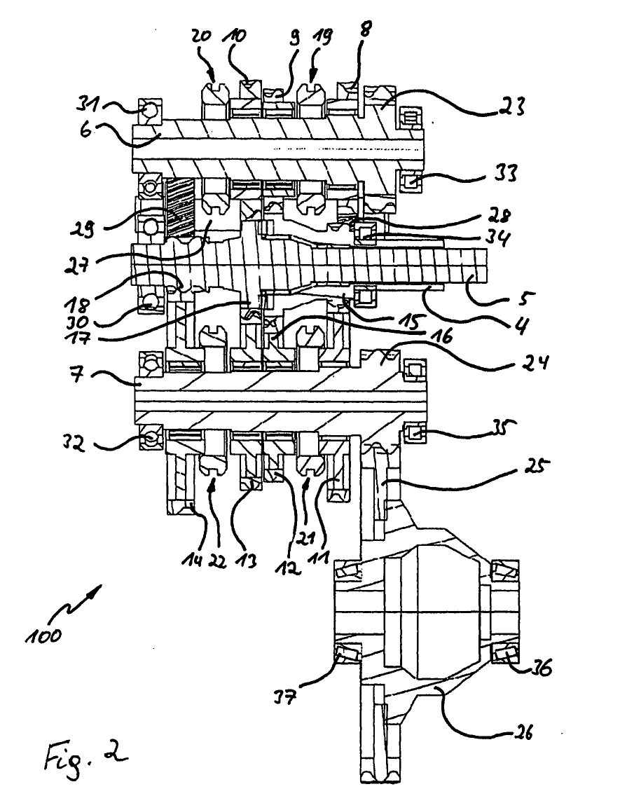

FIG. 2 a schematic sectional representation of the transmission according to FIG. 1;

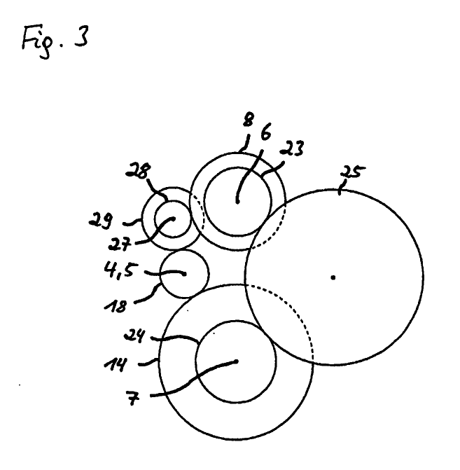

FIG. 3 a schematic side view of the essential gear wheels and shafts of the transmission according to FIGS. 1 and 2.

The transmission 100 shown as an example in FIG. 1 is a dual-clutch transmission having a first clutch 1 and a second clutch 2. The two clutches 1 and 2 are connected with a drive shaft 3 of a drive engine, not shown in any detail here, so as to rotate with it. The drive engine can be an internal combustion engine, which is preferably used in a motor vehicle.

Accordingly, the first clutch 1 is connected to work with a first transmission input shaft 4, whereby the first transmission input shaft 4 is configured as a hollow shaft. Accordingly, the second clutch 2 is connected to work with a second transmission input shaft 5, whereby the second transmission input shaft 5 is configured as a solid shaft.

Furthermore, the transmission 100 has a first countershaft 6 as well as a second countershaft 7. A first idler gear wheel 8, a second idler gear wheel 9, and a third idler gear wheel 10 of the dual-clutch transmission are provided on the first countershaft 6. Additional idler gear wheels 11, 12, 13, and 14 are assigned to the second countershaft 7, so that in total, seven idler gear wheels 8 to 14 are made available on the dual-clutch transmission with the two countershafts 6 and 7. Fixed gear wheels 15, 16, 17 and 18, respectively, of the two transmission input shafts 4 and 5, respectively, can interact with the idler gear wheels 8 to 14 of the two countershafts 6 and 7.

In this connection, the first fixed gear wheel 15 and the second fixed gear wheel 16 are assigned to the first transmission input shaft 4, while the third fixed gear wheel 17 and the fourth fixed gear wheel 18 are assigned to the second transmission input shaft 5.

By means of the interplay of the fixed gear wheels 15 to 18 and the idler gear wheels 8 to 14, a total of six forward gears G1 to G6 and a reverse gear RG can be implemented on the transmission 100.

In order to implement first gear G1, the fourth fixed gear wheel 18, which is carried by the second transmission input shaft 5, can mesh with the seventh idler gear wheel 14 of the second countershaft 7. With regard to second gear G2, the fourth idler gear wheel 11 meshes with the fixed gear wheel 15, which is carried by the first transmission input shaft 4. With regard to third gear G3, the sixth idler gear wheel 13 can mesh with the third fixed gear wheel 17, and fourth gear G4 is implemented by means of the fifth idler gear wheel 12 and the second fixed gear wheel 16. By means of interaction of the third idler gear wheel 10 with the third fixed gear wheel 17, fifth gear G5 of the dual-clutch transmission can be made available, and sixth gear G6 is made possible by means of interaction with the second fixed gear wheel 16 and the second idler gear wheel 9.

So that the first transmission 100 can be built as compact as possible, it comprises coupling devices 19, 20, 21, and 22, by way of which two idler gear wheels 8 and 9, respectively, 11 and 12, respectively, or 13 and 14, respectively, can be coupled with or uncoupled from the countershaft 6 or 7 assigned to them, in each instance. For example, the sixth idler gear wheel 13 of third gear G3 and the seventh idler gear wheel 14 of first gear G1 can be coupled with the second countershaft 7 by means of a single coupling device, namely the fourth coupling device 22. Similar structural conditions exist with regard to second gear G2 and fourth gear G4 with reference to the fourth idler gear wheel 11 and the fifth idler gear wheel 12, respectively, which can enter into active contact with the second countershaft 7 by way of the third coupling device 21. Furthermore, either the first idler gear wheel 8 or the second idler gear wheel 9 can be connected to act with the first countershaft 6, using the first coupling device 19, so that either sixth gear G6 or reverse gear RG can be set on the transmission 100. However, only the third idler gear wheel 10 can be connected to act with the first countershaft 6 by means of the second coupling device 20, thereby then making it possible to set fifth gear G5 on the dual-clutch transmission.

Set accordingly, either the first countershaft 6 can transfer a drive power from the drive shaft 3 to a gearing 25 of a differential 26, by means of a first power take-off gear wheel 23, or the second countershaft 7 can do so by means of a power take-off gear wheel 24.

In advantageous manner, an intermediate shaft 27 can also be driven by means of the fourth fixed gear wheel 18, in order to be able to set the reverse gear RG on the transmission 100, if necessary. For this purpose, the intermediate shaft 27 is connected to act, on the one hand, with a first intermediate shaft fixed gear wheel 28, with the first idler gear wheel 8 of the first countershaft 6, while the intermediate shaft 27, on the other hand, can interact with the fourth fixed gear wheel 18 by means of a second intermediate shaft fixed gear wheel 29.

In advantageous manner, the fourth fixed gear wheel 18 of the transmission 100 that defines first gear G1 and reverse gear RG is disposed axially on the outside in an axial sequence, thereby making it possible to dispose the fourth fixed gear wheel 18, in particular, in the immediate vicinity of a first shaft bearing 30, in advantageous manner. In this regard, vibrations, such as those that can particularly occur during a change in moment, can be greatly reduced on the basis of such an advantageous mounting.

The first shaft bearing 30 is a bearing by means of which the second transmission input shaft 5 can be mounted. In advantageous manner, the first fixed gear wheel 15 of the transmission 100 that defines second gear G2 is disposed on the side of the axial sequence that faces away from the fourth fixed gear wheel 18, also axially on the outside, so that in the case of the present design, the first intermediate shaft fixed gear wheel 28 is disposed at the axial height of the first fixed gear wheel 15 that defines second gear G2, so that the torques that engage on the gear wheels of the transmission 100, in each instance, can be absorbed by the housing of the transmission 100, in correspondingly good manner.

The shaft arrangement of the transmission 100 furthermore has additional shaft bearings 31 to 35, by means of which not only the two transmission input shafts 4 and 5, but also the two countershafts 6 and 7, as well as the intermediate shaft 27, can be mounted in advantageous manner.

In this connection, the two transmission input shafts 4 and 5 are mounted, on the one hand, with the first shaft bearing 30 that has already been explained, and, on the other hand, with the fifth shaft bearing 34.

The first countershaft 6 is mounted by means of the second shaft bearing 31 and the fourth shaft bearing 33, while the second countershaft 7 is mounted by means of the third shaft bearing 32 and the sixth shaft bearing 35. In advantageous manner, not only the first shaft bearing 30 and the second shaft bearing 31 but also the third shaft bearing are situated at one axial height. In this way, the bearing arrangement of the transmission 100 is built in particularly rigid manner.

The differential 26 is furthermore mounted within the transmission 100 in operationally reliable manner, by means of a first power take-off bearing 36 and a second power take-off bearing 37.

In the representation according to FIG. 3, it can be easily recognized how the gearing 25 of the differential 26 meshes with the first power take-off gear wheel 23 of the first countershaft 6 of the transmission 100, on the one hand, and with the second power take-off gear wheel 24 of the second countershaft 7 of the transmission 100, on the other hand.

On the first countershaft 6, the first idler gear wheel 8 meshes with the first intermediate shaft fixed gear wheel 28 of the intermediate shaft 27, whereby the second intermediate shaft fixed gear wheel 29 of the intermediate shaft 27 in turn interacts with the fourth fixed gear wheel 18 of the second transmission input shaft 5. At the same time, the fourth fixed gear wheel 18 meshes with the seventh idler gear wheel 14 of the second countershaft 7, thereby forming first gear G1 of the transmission 100.

In the transmission 100, the fixed gear wheel 18 that defines first gear G1 and reverse gear RG, in each instance, can be placed in the immediate vicinity of the shaft bearing 30, in advantageous manner, thereby minimizing loads that can occur in the transmission 100, in each instance, during normal operation, for example, or also in the case of moment changes, in extraordinarily good manner. In particular, the gear engagement forces or vibrations such as those that can occur during a change in moment can be minimized.

### REFERENCE SYMBOL LIST

1 first clutch
2 second clutch
3 drive shaft
4 first transmission input shaft
5 second transmission input shaft
6 first countershaft
7 second countershaft
8 first idler gear wheel
9 second idler gear wheel
10 third idler gear wheel
11 fourth idler gear wheel
12 fifth idler gear wheel
13 sixth idler gear wheel
14 seventh idler gear wheel
15 first fixed gear wheel
16 second fixed gear wheel
17 third fixed gear wheel
18 fourth fixed gear wheel
19 first coupling device
20 second coupling device
21 third coupling device
22 fourth coupling device
23 first power take-off gear wheel
24 second power take-off gear wheel
25 gearing
26 differential
27 intermediate shaft
28 first intermediate shaft fixed gear wheel
29 second intermediate shaft fixed gear wheel
30 first shaft bearing
31 second shaft bearing
32 third shaft bearing
33 fourth shaft bearing
34 fifth shaft bearing
35 sixth shaft bearing
36 first power take-off bearing
37 second power take-off bearing
38 shaft end
100 transmission
G1 first gear
G2 second gear
G3 third gear
G4 fourth gear
G5 fifth gear
G6 sixth gear
RG reverse gear

1-11. (canceled)

12. Transmission (100) having two transmission input shafts (4, 5) disposed coaxial to one another, having two counter shafts (6, 7) on which gear wheels for the different gears, configured as idler gear wheels (8, 9, 10, 11, 12, 13, 14), are mounted so as to rotate, having gear wheels for the different gears, configured as fixed gear wheels (15, 16, 17, 18), disposed on the two transmission input shafts (4, 5) so as to rotate with them and disposed in an axial sequence, which stand in gear engagement with the idler gear wheels (8, 9, 10, 11, 12, 13, 14), directly or indirectly, and thereby define different gears, having coupling devices (19, 20, 21, 22) that are mounted on the two countershafts (6, 7) so as to rotate with them and in axially movable manner, and can be moved axially by means of setting devices (19, 20, 21, 22), in order to connect a idler gear wheel (8, 9, 10, 11, 12, 13, 14), in each instance, with the corresponding counter shaft (6, 7), so as to rotate with it, and having a power take-off gear wheel (23, 24), attached to the two counter shafts (6, 7), in each instance, whereby the power take-off gear wheels (23, 24) stand in gear engagement with a gearing (25) of a power take-off, whereby a reverse gear (RG) is defined by an intermediate shaft (27), on which a first intermediate shaft fixed gear wheel (28), which directly stands in gear engagement with an idler gear wheel (8) of the idler gear wheels (8, 9, 10, 11, 12, 13, 14), and a second intermediate shaft fixed gear wheel (29) that directly stands in gear engagement with a fixed gear wheel (18) of the fixed gear wheels (15, 16, 17, 18) that defines first gear (G1), are mounted so as to rotate with it, whereby the fixed gear wheel (18) that defines first gear (G1) and reverse gear (RG) is disposed axially on the outside, in the axial sequence, and whereby the fixed gear wheel (15) that defines second gear (G2) is disposed axially on the outside, on the side of the axial sequence that faces away from the fixed wheel (18) that defines first gear (G1) and reverse gear (RG), wherein the first intermediate shaft fixed gear wheel (28) is disposed at the axial height of the fixed gear wheel (15) that defines second gear (G2).

13. Dual-clutch transmission as a transmission according to claim 12, having two clutches (1, 2), the input sides of which are connected with a drive shaft (3) of a drive engine and the output sides of which are connected, in each instance, with one of the two transmission input shafts (4, 5) that are disposed coaxial to one another, wherein the fixed gear wheel (18) that defines first gear (G1) and reverse gear (RG) is disposed axially on a side of the axial sequence that faces away from the clutches (1, 2).

14. Dual-clutch transmission according to claim 13, wherein the fixed gear wheel (15) that defines second gear (G2) is disposed axially on a side of the axial sequence that faces the clutches (1, 2).

15. Dual-clutch transmission as a transmission according to claim 12, having two clutches (1, 2), the input sides of which are connected with a drive shaft (3) of a drive engine and the output sides of which are connected, in each instance, with one of the two transmission input shafts (4, 5) that are disposed coaxial to one another, wherein the fixed gear wheel (18) that defines first gear (G1) and reverse gear (RG) is disposed axially on a side of the axial sequence that faces the clutches (1, 2).

16. Dual-clutch transmission according to claim 15, wherein the fixed gear wheel (15) that defines second gear (G2) is disposed axially on a side of the axial sequence that faces away from the clutches (1, 2).

17. Dual-clutch transmission according to claim 13, wherein the two clutches (1, 2) are disposed axially at the same height or axially with an overlap of more than 50%, and radially on different radii, relative to one another.

18. Dual-clutch transmission according to claim 17, wherein the clutch (1, 2) connected with the fixed gear wheel (18) that defines first gear (G1) and reverse gear (RG) is disposed radially on the outside.

19. Transmission (100) according to claim 12, wherein the two transmission input shafts (4, 5) can be coupled with one another.

20. Transmission (100) according to claim 12, wherein the power take-off comprises a differential (26).
